(19) United States
(12) Patent Application Publication
(10) Pub. No.: US 2004/0049466 A1
(43) Pub. Date: Mar. 11, 2004

(54) Optical disk trading card

(76) Inventor: David Lee Black, Advance, NC (US)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/654,766

(22) Filed: Sep. 4, 2003

Related U.S. Application Data
(60) Provisional application No. 60/409,855, filed on Sep. 11, 2002.

(51) Int. Cl. H04L 9/00

(52) U.S. Cl. 705/51

(57) ABSTRACT

An adaptation of a paperboard or cardstock trading card to digital format through the use of an optical disk. The optical disk trading card has an irregular shape, a non-data side, and a data side. The data side of the trading card contains an annular data track having stored information recorded in a digital format, which can be read by a conventional optical disk reader. The non-data side of the trading card contains visual material evocative of a traditional paper trading card. The irregular shape of the trading card is consistent with the visual material contained on the non-data side. The data comprises information relating to the visual material on the non-data side of this disk.

### TECHNICAL FIELD AND BACKGROUND OF THE INVENTION

This application claims the benefit of Provisional Application No. 60/409,855, filed on Sep. 11, 2002.

This invention relates to an optical disk trading card. Optical disks presently take many forms, and include plastic disks which contain digital data which may represent computer software, music, video, graphics and many other types of digital data. Such disks are presently made in many sizes and are referred to by different names, for example, CD's, CD-ROM's, compact disks, optical disks, DVD's, and include unrecorded disks which can be “burned” by consumers and disks which are capable of being recorded and then re-recorded. These disks are typically circular.

Optical disks are also now made and sold which have irregular shapes, and are used for many purposes, including business advertising. Such disks can be formed in virtually any shape so long as they will fit into and function in a disk player. One such shape commonly made and distributed is a “business card” disk, which comprises a optical disk which has been cut down in size so that two of the opposing sides are parallel, and the other two opposing sides are convex. The principal requirement for such disks is that the data area exist as a continuous annular area symmetrically positioned around the center hole by which the optical disk is placed on the drive spindle of a disk player. Such disks are approximately the size of a business card, or somewhat larger, and easily fit in, for example, a shirt pocket.

This application relates generally to all types of optical disks, but particularly to so-called “CD-ROM's.”

More particularly, the invention relates to an adaptation of a well-known paperboard or cardstock product—trading cards—to digital format. Trading cards in paper form have been known for over a century, and older such cards, particularly of famous individuals, often have significant value as collectible items. The appeal of these products is based on several factors:

1. the trading cards relate to a sport or other subject that enjoys a passionate fan base;

2. the cards display a photo or illustration of an individual participant or personality in the sport or activity, as well as a history, in both text and data form, of the personality's performance and achievements, so that ownership of the card provides a sense of connection with that personality;

3. they are compact and relatively durable, making them easy to store and trade; and

4. they are relatively inexpensive, and are issued seasonally and in limited quantities, making them collectable.

### SUMMARY OF THE INVENTION

Therefore, it is an object of the invention to provide a CD comprising a trading card, wherein information is recorded and stored on the CD in digital form for being read by a conventional optical disk reader.

It is another object of the invention to provide a CD comprising a trading card, wherein information is recorded and stored on the CD in digital form for being read by a conventional optical disk reader, and further wherein the non-data side of the CD contains visual material evocative of a traditional paper trading card.

It is another object of the invention to provide a CD comprising a trading card having a non-circular peripheral shape.

These and other objects of the present invention are achieved in the preferred embodiments disclosed below by providing an optical disk trading card for adaptation of paperboard or cardstock product, trading cards, to digital format. The optical disk includes a planar disk with a non-data side, a data side, an irregular, non-circular shape, and text and graphics applied to the non-data side. The optical disk also includes a hole for receiving the spindle of a CD playback device.

According to another preferred embodiment of the invention, the text and graphical material is applied to the non-data side by silk screening.

According to another preferred embodiment of the invention, the text and graphical material is applied to the non-data side by using an adhesive label.

According to another preferred embodiment of the invention, the adhesive label is made of paper.

According to another preferred embodiment of the invention, the adhesive label is made of foil.

According to another preferred embodiment of the invention, the silk screening is printed around the hole of the optical disk.

According to another preferred embodiment of the invention, the adhesive label includes a hole that matches up with the hole in the disk.

According to another preferred embodiment of the invention, the adhesive label has intersecting slits positioned over the hole in the optical disk.

According to another preferred embodiment of the invention, the data side includes an annular data track.

According to another preferred embodiment of the invention, the data includes at least one element of data from the group including statistical information, audio, video, secret areas, and interactive areas; related by subject matter to the text and graphics, applied to the non-data side of the disk.

According to another preferred embodiment of the invention, the data includes statistical information, audio, video, secret areas, and interactive areas; related by subject matter to the text and graphics, applied to the non-data side of the disk.

According to another preferred embodiment of the invention, the data includes statistics, audio, and video; related by subject matter to the text and graphics applied to the non-data side of the disk.

According to another preferred embodiment of the invention, desired irregular and non-circular shapes include an automobile, an animal, or an athlete.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a plan view of a CD trading card according to an embodiment of the invention;

FIG. 2 is a plan view of the obverse, data side of the trading card shown in FIG. 1;

FIG. 3 is an alternative embodiment wherein the visual material on the non-data side of the CD is in the form of a label with intersecting slits in the center to permit printing where the hole would ordinarily be visible; and

FIG. 4 is a plan view of the obverse, data side of the trading card shown in FIG. 3.

### DESCRIPTION OF THE PREFERRED EMBODIMENT AND THE BEST MODE

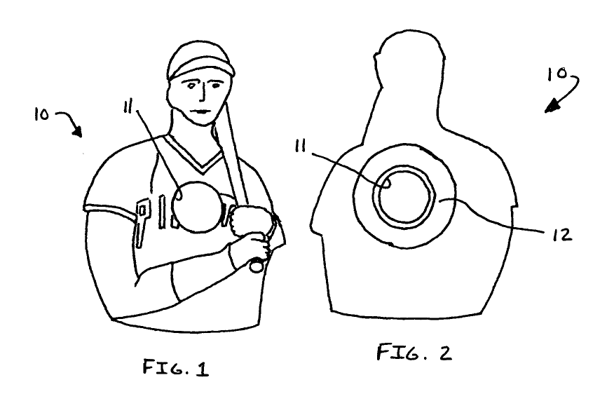

Referring now specifically to the drawings, a CD trading card according to the present invention is illustrated in FIG. 1 and shown at reference numeral 10. The particular embodiment shown is profiled to exhibit the general outline shape of the upper torso of a baseball player. The size and shape of the CD trading card is not critical so long as it is sized to play in a conventional CD or DVD playback device. The CD card could take the shape of an automobile, animal, athlete or any other desired shape within the size and shape requirements of the playback device.

The CD trading card includes a standard hole 11 for receiving the spindle of a conventional CD playback device. The obverse side of the CD trading card includes a standard annular data track 12. The front, non-data side is used to apply text and/or graphical material either by printing or by means of label. Text and graphics labels are generally applied to the optical disk by silk screening onto one side of the disk, or by applying an adhesive paper or foil label to the non-data side of the disk. The silk screening process prints around the hole in the center of the disk, and labels include a hole which is aligned with the hole in the disk. As used in this application, the term “label”, except as otherwise defined or clear from context, refers to a means by which text and/or graphics material is applied to the disk, whether by silk screening, application of a sheet label, other otherwise. The graphical and text material can include the name of the personality, as well as trademarked logos of the sports league or other sponsored activity. The disk will auto-play in a conventional manner when inserted in a computer CD-ROM drive, and can display any data relating to the personality—textual, statistical, or graphical—that is desired. Such disks are inexpensive to produce, particularly when produced in quantity by commercial pressing methods rather than by “burning” CD-R's one-by-one.

There are several advantages of such CD-cards over traditional paper trading cards. CDs are more durable than pasteboard. In addition to extending the lifetime of the collectable, the durability of the material and the data track itself makes it possible to issue the CD cards in irregular shapes, enhancing their appeal and marketability. The shape of and graphics displayed on the CD identify and depict the subject in an immediately accessible way for purposes of merchandising, trading and collecting.

The data side of the CD-card, by contrast, would not be readable without the use of a computer, which also offers significant marketing advantages. It allows the creation of a sense of discovery and anticipation, enhancing the desire of the fan to acquire the disk. With traditional trading cards, all of the information on the card is readily visible, but a CD card has the appeal of offering vastly more information and entertainment than what can be seen merely by viewing the exterior.

Because of the high data capacity of even small CD's, more statistical information can be provided on such a CD than on any type of a paper trading card. There also exists the ability to display such data in more compelling and accessible ways. For example, a CD-card for a race car driver could display a 3D-rendered racetrack when inserted, with each turn being a “hot-spot” to display different information about the driver—team sponsorship, driving record, top finishes, personal history, videos of greatest moments (most exciting finishes, most spectacular crashes, best passes). A CD-card for a baseball star could begin with a video message from the athlete himself, and include not only all his lifetime statistics in searchable format, but photos and videos of his best plays. Both video and audio data may be stored on a CD, so the voice of the personality depicted on the card may be included, as may short segments of play-by-play action, awards ceremonies or narration of the graphical material being displayed.

“Easter eggs” or secret areas can also be included on the CD to enhance interest. The CD medium would also provide many more marketing opportunities than traditional cards, including display of sponsored messages, digital coupons for merchandise or services, and embedded links to sponsored websites.

The CD card may be digitally locked to prevent unauthorized copying, and embedded identification codes could assure authenticity. As with traditional paper trading cards, CD trading cards may also be numbered and sold in sets or series. Display cases and filing drawers may be designed specifically to hold and protect the CD cards. Protective paper or film sleeves containing a visual representation of the CD trading card may be used for protecting the card during shipping, storage and display for sale.

Interactive areas may be included, where, for example, a participant answers quizzes contained on the CD trading card and is graded according to the correct answers.

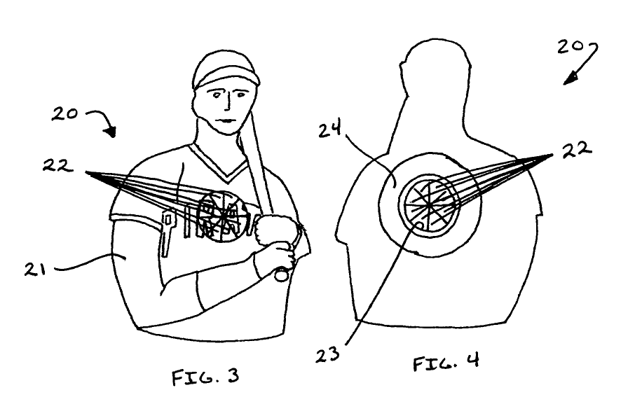

As is shown in FIG. 3, a CD card 20 is shown with a label 21 which includes a plurality of intersecting slits 22 positioned over the spindle hole 23 in the CD card. This permits printing on the area where the hole 23 would normally be visible and would substantially detract from the attractiveness of the CD card. Using the label 21 permits larger graphics and more text than is the case with conventional labeling or screen printing techniques. The form of label shown in FIGS. 3 and 4 is the subject of a pending patent application by Concept Design Manufacturing and Electronics, Inc. of Burlington, N.C. and is not claimed by the present inventor.

An optical disk trading card with an annular data track has been described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

I claim:

1. A optical disk trading card, comprising:
(a) a planar disk having a non-data side, a data side, and a perimeter having a desired, irregular, non-circular shape;
(b) text and graphics applied to said non-data side to identify the disk as a trading card; and
(c) at least one element of data recorded on the data side of the optical disk, the data selected from the group consisting of statistics, audio, video, a secret data area, and an interactive area; said at least one element of data related by subject matter to the text and graphics applied to the non-data side of the disk.

2. The optical disk trading card according to claim 1, wherein the data comprises statistics, audio, video, a secret data area, and an interactive area; said data related by subject matter to the text and graphics applied to the non-data side of the disk.

3. The optical disk trading card according to claim 1, further comprising a hole for receiving the spindle of a CD playback device.

4. The optical disk trading card according to claim 1,wherein the text and graphical material is silk screened onto the non-data side of the disk.

5. The optical disk trading card according to claim 1, wherein the text and graphical material is on an adhesive label applied to the non-data side of the disk.

6. The optical disk trading card according to claim 1, wherein the data comprises statistics, audio, and video related by subject matter to the text and graphics applied to the non-data side of the disk.

7. The optical disk trading card according to claim 5, wherein the adhesive label is foil.

8. The optical disk trading card according to claim 5, wherein the adhesive label is paper.

9. The optical disk trading card according to claim 4, wherein the silk screening process, prints around the hole of the disk.

10. The optical disk trading card according to claim 5, wherein the adhesive label includes a hole which is aligned with the hole of the disk.

11. The optical disk trading card according to claim 5, wherein the adhesive label has a plurality of intersecting slits positioned over the hole of the disk.

12. The optical disk trading card according to claim 1, in which said data side comprises an annular data track.

13. The optical disk trading card according to claim 1, wherein said irregular, non-circular shape comprises: an automobile, an animal, or an athlete.
